(19) United States
(12) Patent Application Publication
(10) Pub. No.: US 2008/0120905 A1
(43) Pub. Date: May 29, 2008

(54) SECTIONAL-TYPE RAISED GARDENING BED STRUCTURE

(76) Inventor: Hung Ta Pai, Hsinchu (TW)

Correspondence Address: PAI PATENT & TRADEMARK LAW FIRM, 1001 FOURTH AVENUE, SUITE 3200, SEATTLE, WA, 98154, US

(21) Appl. No.: 11/942,872

(22) Filed: Nov. 20, 2007

(30) Foreign Application Priority Data
Nov. 24, 2006 (TW) 95220756

(51) Int. Cl. A01G 9/02

(52) U.S. Cl. 47/66.1

(57) ABSTRACT

A sectional-type raised garden bed structure includes a first wall section being provided at an end with at least one mortise, a second wall section being provided at an end with at least one tenon adapted to engage with the at least one mortise on the first wall section for connecting the first and the second wall section together. The tenon is flexible for the connected first and second wall sections to contain a predetermined angle therebetween according to actual need.

### FIELD OF THE INVENTION

The present invention relates to a sectional-type raised gardening bed structure, and more particularly to a sectional-type raised gardening bed structure including a plurality of wall sections that can be easily connected together via mortises and flexible tenons provided thereon as well as links without limitation in size and shape.

### BACKGROUND OF THE INVENTION

Most people living in the modern society are busy in working without too much time for contacting with the natural environment. Some people try to utilize limited space available at their house, such as at roof, patio, balcony, door front, or some indoor free corners, to arrange areas for growing plants or vegetables, so as to enjoy simple and natural life through gardening after work.

Generally, such areas for growing plants or vegetables are defined by flowerpots or enclosed in stacked and cement-bonded bricks or stones. Soil is filled in the flowerpots and the spaces enclosed by the cement-bonded brick or stone walls for growing personal favorite plants. The cement-bonded brick or stone wall is not economical for use because it requires a professional worker to build and maintain and accordingly, involves long working hours and high labor cost. In the case of flowerpots, each flowerpot has limited space and is usually suitable for growing only one type of plant therein. Therefore, a plurality of flowerpots is needed if different plants are to be cultured.

It is therefore tried by the inventor to develop a sectional-type raised gardening bed structure that allows a user to conveniently and flexibly design and plan differently sized gardening beds for growing different types of plants.

### SUMMARY OF THE INVENTION

A primary object of the present invention is to provide a novel and improved sectional-type raised gardening bed structure to enable flexible design of differently sized and shaped gardening beds that could be conveniently combined together according to actual need.

To achieve the above and other objects, the sectional-type raised gardening bed structure according to an embodiment of the present invention includes a first wall section provided at an end with at least one mortise; and a second wall section provided at an end with at least one tenon adapted to engage with the at least one mortise on the first wall section to thereby connect the first and the second wall section together. Wherein, the tenon is flexible for the connected first and second wall sections to contain a desired angle therebetween according to actual need.

In another embodiment of the present invention, the sectional-type raised gardening bed structure further includes at least one bottom plate provided with a first connector for engaging with a second connector provided on the first and the second wall section.

In an embodiment, the first connector is a post, and the second connector is a recessed hole.

In another embodiment, the first connector is a recessed hole, and the second connector is a post.

In a sectional-type raised gardening bed structure according to a further embodiment of the present invention, the first wall section is provided at another opposite end with at least one tenon, and the second wall section is provided at another opposite end with at least one mortise adapted to receive and engage with the at least one tenon on the first wall section.

In an embodiment of the present invention, the first wall section is further provided on one lateral side with at least one hole for a support to insert thereinto.

In another embodiment of present invention, the second wall section is further provided on one lateral side with at least one hole for a support to insert thereinto.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a wall section for a sectional-type raised gardening bed structure according to a first embodiment of the present invention;

FIG. 2 is a perspective view of a square-shaped sectional-type raised gardening bed structure according to the first embodiment of the present invention assembled from four wall sections of the type shown in FIG. 1;

FIG. 3 is a perspective view of a variant of the wall section of FIG. 1 for the sectional-type raised gardening bed structure of the first embodiment of the present invention;

FIG. 4 is a perspective view showing the assembling of a bottom plate to two wall sections of FIG. 3;

FIG. 5 is a perspective view of the sectional-type raised gardening bed structure according to the first embodiment of the present invention with supports assembled thereto for growing climbers;

FIG. 6 is an exploded plan view of a sectional-type raised gardening bed structure according to a second embodiment of the present invention;

FIG. 7 is an assembled plan view of a sectional-type raised gardening bed structure according to a third embodiment of the present invention; and

FIG. 8 is a schematic side view of a sectional-type multi-tiered raised gardening bed structure according to a fourth embodiment of the present invention.

### DETAILED DESCRIPTION OF THE PREFERRED EMBODIMENTS

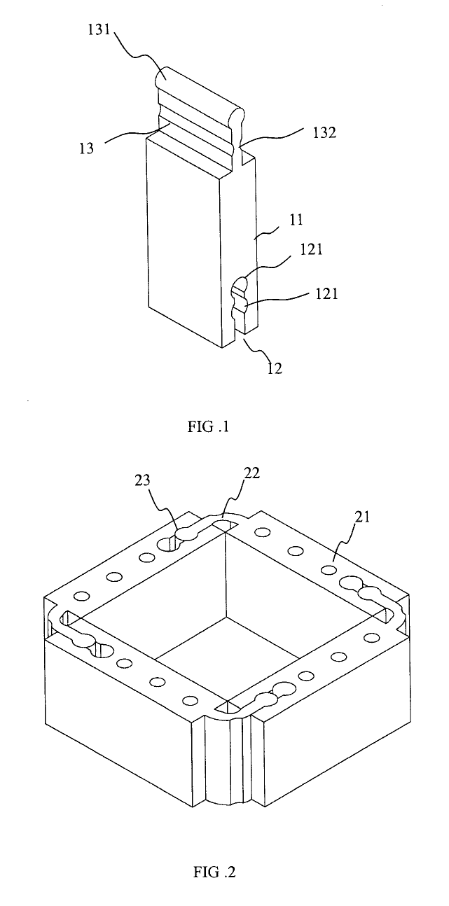

Please refer to FIG. 1 that is a perspective view of a wall section 11 for a sectional-type raised gardening bed structure according to a first embodiment of the present invention. As shown, the wall section 11 is provided at an end with a mortise 12, and at another end with a tenon 13 opposite to the mortise 12. The mortise 12 internally includes two longitudinally spaced and size-expanded round recess portions 121, and the tenon 13 includes a transverse and size-expanded round column portion 131 formed at a free end thereof and a flexible neck portion 132 spaced from the round column portion 131 and a root of the tenon 13 by a predetermined distance each. The two spaced round recess portions 121 in the mortise 12 on a first wall section 11 are adapted to receive and fitly engage with the round column portion 131 on a second wall section 11. Similarly, the round column portion 131 of the tenon 13 on a first wall section 11 is adapted to engage with any one of the two round recess portions 121 in the mortise 12 on a second wall section 11. The tenon 13 may be bent at the flexible neck portion 132. A plurality of wall sections 11 may be continuously connected through engagement of the tenon 13 with the mortise 12 to form differently sized and shaped raised gardening beds.

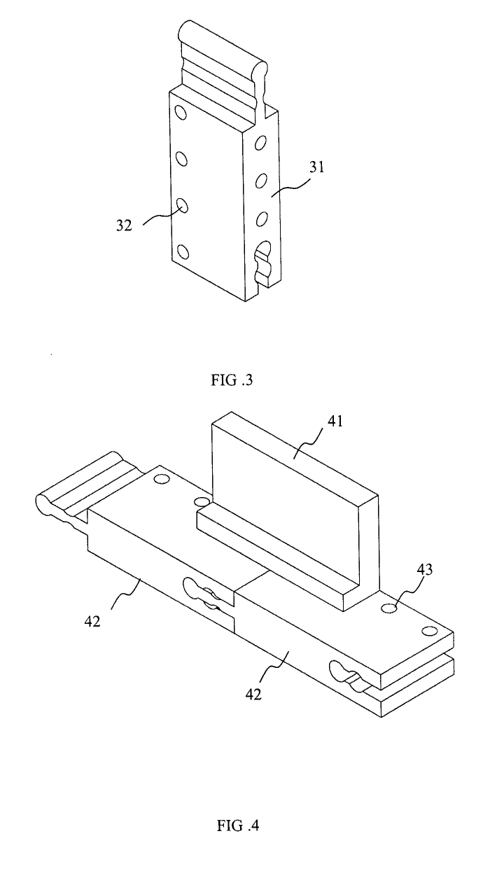

FIG. 2 is a perspective view of a square-shaped sectional-type raised gardening bed structure according to the first embodiment of the present invention assembled from four pieces of wall sections 21 similar to the wall section 11 of FIG. 1. As shown, a tenon on each of the wall sections 21 is received in and engaged with a mortise 23 on a preceding wall section 21 with a flexible neck portion 22 of each wall section 21 being bent by substantially 90 degrees to form the square-shaped raised gardening bed structure. Similarly, when it is desired to form other differently sized and shaped raised gardening bed structure, simply change the number of the wall sections to meet actual need. In other words, identical wall sections are used in the sectional-type raised gardening bed structure according to the first embodiment of the present invention, and a user needs only to prepare a predetermined number of the wall sections to form a sectional-type raised gardening bed structure having a desired size and shape to enjoy the pleasure of gardening.

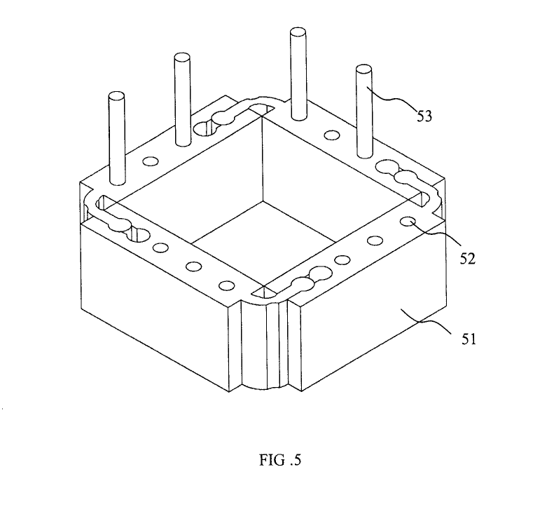

FIG. 3 is a perspective view of a variant of the wall section of FIG. 1 for the sectional-type raised gardening bed structure according to the first embodiment of the present invention. As shown, the variant wall section is denoted a reference numeral 31, and is similar to the wall section 11 except for a row of recessed holes 32 provided along at least one edge on at least one face of the wall section 31 for receiving posts provided on a bottom plate, so as to connect one or more bottom plates to the assembled wall sections 31. In another feasible embodiment, the variant wall section may be provided with posts for engaging with recessed holes formed on a bottom plate. The number of the recessed holes 32 may be determined according to actual design. And, two or more rows of recessed holes 32 may be formed on the wall section 31, if necessary.

FIG. 4 is a perspective view showing the assembling of a bottom plate 41 to two assembled wall sections 42, which are the same type as the variant wall section of FIG. 3 and have a plurality of recessed holes 43. As shown, the bottom plate 41 may be connected to and between two assembled wall sections 42, enabling the two wall sections 42 to be more firmly connected together. The bottom plate 41 is provided at one side with outward projected posts (not shown) for inserting into at least some of the recessed holes 43 on the wall sections 42.

FIG. 5 is a perspective view of the sectional-type raised gardening bed structure according to the first embodiment of the present invention with supports assembled thereto for growing climbers. As shown, the sectional-type raised gardening bed structure of FIG. 5 includes a plurality of identical wall sections 51, each of which is provided on at least one lateral side with a plurality of recessed holes 52, each of which may have a support 53 inserted thereinto. The supports 53 allow the constructing of a net frame for growing climbers on the sectional-type raised gardening bed structure according to the first embodiment of the present invention. Or, a sunscreen cover (not shown) may be supported on a top of the supports 53.

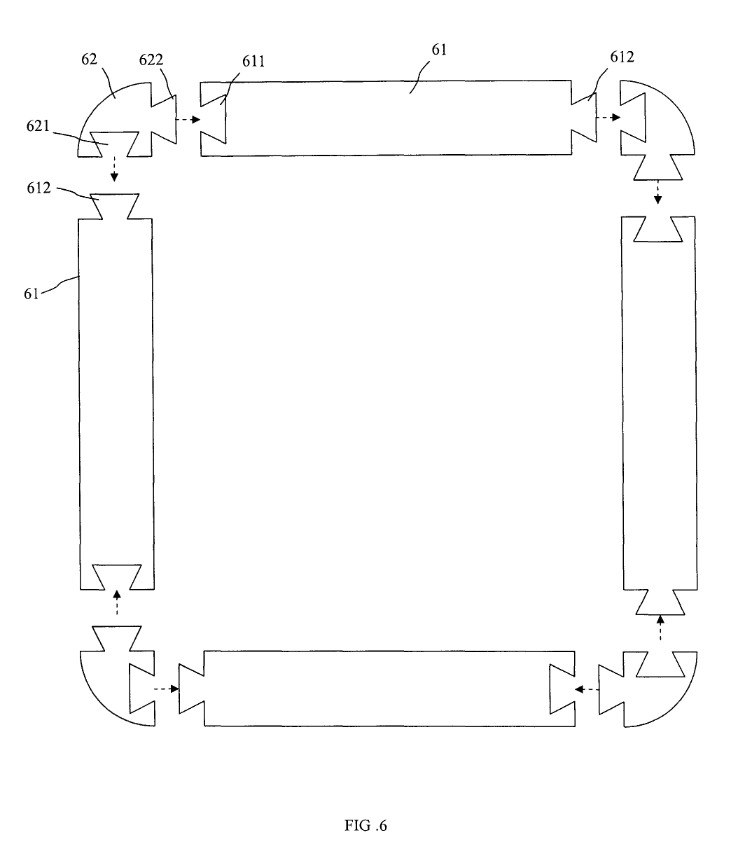

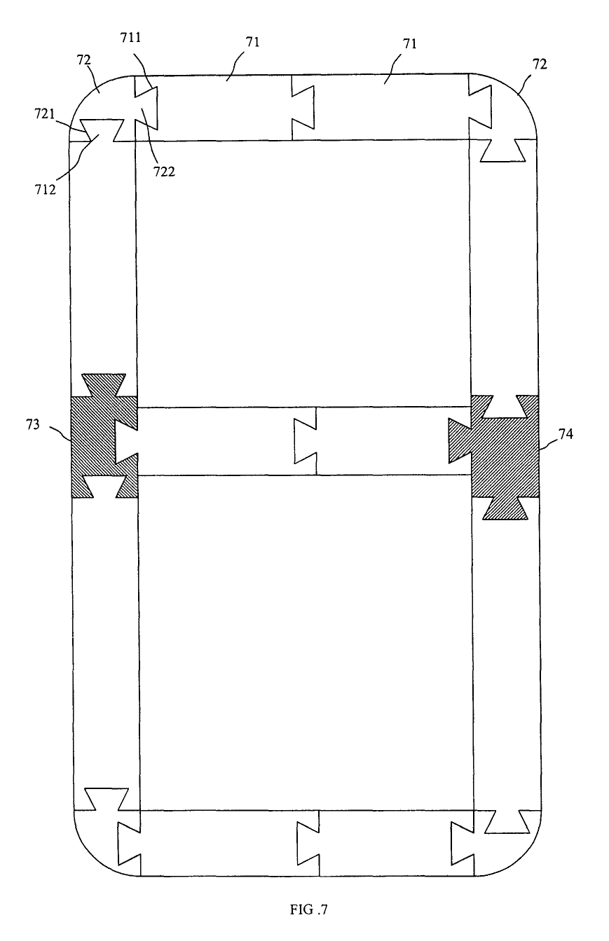

FIG. 6 is an exploded plan view of a sectional-type raised gardening bed structure according to a second embodiment of the present invention. As shown, the sectional-type raised gardening bed structure of the second embodiment of the present invention includes a plurality of wall sections 61 and a plurality of corner links 62. Each of the wall sections 61 is provided at an end with a mortise 611 and at another end with a tenon 612 opposite to the mortise 611; and each of the corner links 62 is provided at an end with a mortise 621 and at another with a tenon 622 perpendicular to the mortise 621. The tenon 622 on each corner link 62 may be fitly received in and engaged with the mortise 611 on one wall section 61; and the mortise 621 on each corner link 62 may fitly receive and engage with the tenon 612 on another wall section 61. A square-shaped raised gardening bed structure according to the second embodiment of the present invention as illustrated in FIG. 6 may be assembled from four pieces of the wall sections 61 using four corner links 62. With the corner links 62, the completed sectional-type raised gardening bed structure of the second embodiment of the present invention may have relatively safe and beautiful corners.

FIG. 7 is an assembled plan view of a sectional-type raised gardening bed structure according to a third embodiment of the present invention. In the illustrated third embodiment, the sectional-type raised gardening bed structure of the present invention is assembled from ten pieces of wall sections 71, four pieces of first links 72, a second link 73, and a third link 74 to define two separated growing areas therein. The wall sections 71 are identical in structure but may have different lengths. Each of the wall sections 71 is provided at an end with a mortise 711 and at another end with a tenon 712 opposite to the mortise 711. The first links 72 are corner links, each of which is provided at an end with a mortise 721 and at another end with a tenon 722 perpendicular to the mortise 721. The second link 73 is an in-line link provided at two opposite ends with a first mortise and a tenon, and at one side with a second mortise. The third link 74 is also an in-line link provided at two opposite ends with a mortise and a first tenon, and at one side with a second tenon.

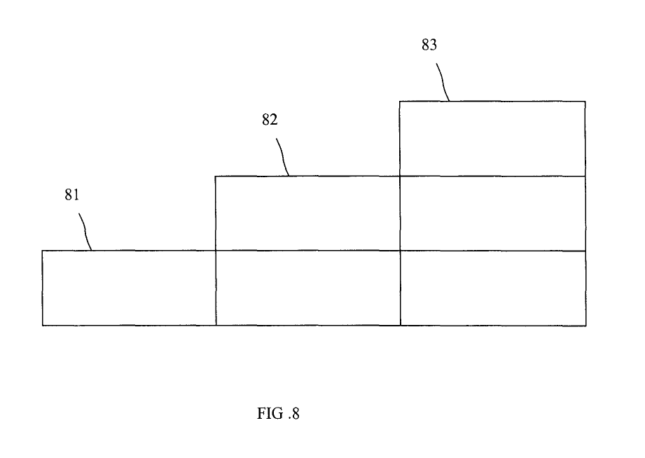

FIG. 8 is a schematic side view of a sectional-type multi-tiered raised gardening bed structure according to a fourth embodiment of the present invention. The sectional-type multi-tiered raised gardening bed structure in the fourth embodiment is assembled using the wall sections and the links for forming the sectional-type raised gardening bed structure with separated growing areas in the third embodiment. The fourth embodiment of the present invention illustrated in FIG. 8 includes three levels in a tiered shape, and is therefore divided into a first growing zone 81, a second growing zone 82, and a third growing zone 83. The first, the second, and the third growing zone 81, 82, 83 are different in depth for different types of plants. The first growing zone 81 has a small depth suitable for growing a shallow-rooted plant; and the third growing zone 83 has a relatively large depth suitable for growing a deep-rooted plant.

The sectional-type raised gardening bed structure of the present invention can be easily assembled from identically structured wall sections to have different sizes and shapes and more than one growing zones for holding soil and culturing desired plants at low cost. Moreover, the sectional-type raised gardening bed structure of the present invention can be easily expanded to have multiple levels in tiered shape for growing differently rooted plants. Therefore, the sectional-type raised gardening bed structure of the present invention is novel and practical for use.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A sectional-type raised gardening bed structure, comprising:
a first wall section being provided at an end with at least one mortise; and
a second wall section being provided at an end with at least one tenon adapted to engage with the at least one mortise provided on the first wall section for connecting the first and the second wall section together; and
wherein the tenon is flexible for the connected first and second wall sections to contain a predetermined angle therebetween according to actual need.

2. The sectional-type raised gardening bed structure as claimed in claim 1, further comprising at least one bottom plate, and the bottom plate being provided with at least one first connector adapted to engage with at least one second connector provided on the first and the second wall section.

3. The sectional-type raised gardening bed structure as claimed in claim 2, wherein the first connector is a post, and the second connector is a recessed hole.

4. The sectional-type raised gardening bed structure as claimed in claim 2, wherein the first connector is a recessed hole, and the second connector is a post.

5. The sectional-type raised gardening bed structure as claimed in claim 1, wherein the first wall section is provided at another opposite end with at least one tenon, and the second wall section is provided at another opposite end with at least one mortise adapted to receive and engage with the at least one tenon provided on the first wall section.

6. The sectional-type raised gardening bed structure as claimed in claim 1, wherein the first wall section is provided on a lateral side with at least one recessed hole adapted to receive a support therein.

7. The sectional-type raised gardening bed structure as claimed in claim 1, wherein the second wall section is provided on a lateral side with at least one recessed hole adapted to receive a support therein.

8. A sectional-type raised gardening bed structure, comprising:
a first wall section being provided at two opposite ends with a mortise and a tenon; and
a second wall section being provided at two opposite ends with a mortise and a tenon; and
wherein the tenon on the first wall section is adapted to engage with the mortise on the second wall section for connecting the first wall section to the second wall section.

9. A sectional-type raised gardening bed structure, comprising:
a first wall section provided with a first mortise;
a second wall section provided with a first tenon; and
a first link provided with a second mortise and a second tenon; the second tenon being adapted to engage with the first mortise on the first wall section, and the second mortise being adapted to receive and engage with the first tenon on the second wall section, so that the first and the second wall section are connected via the first link.

10. The sectional-type raised gardening bed structure as claimed in claim 9, further comprising a second link provided with two second mortises and one second tenon, and a third link provided with one second mortise and two second tenon.
